(19) United States
(12) Patent Application Publication
(10) Pub. No.: US 2007/0299763 A1
(43) Pub. Date: Dec. 27, 2007

(54) Resource management apparatus, computer readable medium and information processing apparatus

(75) Inventor: Hideki Yoshida, Ota-ku (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/713,748

(22) Filed: Mar. 5, 2007

(30) Foreign Application Priority Data
Jun. 26, 2006 (JP) P2006-175812

(51) Int. Cl. G06Q 40/00

(52) U.S. Cl. 705/37

(57) ABSTRACT

A resource management apparatus includes: a plurality of resource bidders; a bid manager; a repetition controller. The plurality of resource bidders are respectively provided for a plurality of application programs, each of which consumes and/or supplies resources. Each of the resource bidders calculates a current bid price for each of the resources to be supplied or consumed by the associated application program within a unit time to generate current bidding information about the current bid price. The bid manager performs an allocation process to allocate the resources to the application programs through a bidding process based on the current bidding information generated by each of the resource bidders. The repetition controller controls the bid manager to repeat the allocation process until a bidding stop condition is satisfied within the unit time.

### CROSS-REFERENCE TO RELATED APPLICATIONS

This application is based upon and claims the benefit of priority from the prior Japanese Patent Application No. 2006-175812, filed on Jun. 26, 2006; the entire contents of which are incorporated herein by reference.

### BACKGROUND

1. Field

The present invention relates to a resource management apparatus for managing resources that a plurality of application programs individually consume or supply during a predetermined time period, and a resource management method and an information processing apparatus.

2. Related Art

As related art, so-called real time systems that employ sensors are known. In the transport machinery such as ships, airplanes and automobiles, sensor information systems are employed, which obtain status information for areas around the transport machinery and display the information on screens to provide the status information for operators. The sensor information system employed for a ship, for example, includes a plurality of sensors, such as radar, sonar, infrared sensing device and camera. The system analyzes signals provided by one or more sensors according to aspects, and assembles information that reflects the status of the surrounding area. The assembled information is then displayed on devices such as a screen. The status of the surrounding area is helpful for safety navigation of the ship.

The sensor information system used in the transport machinery has to update the status information displayed on a screen within a predetermined time period, and ensure that the current status information around the transport machinery is constantly provided for operators. That is because otherwise the status information is not grasped by the operators quickly and a serious accident such as a truck or train crash may occur. Therefore, the sensor information system has to be the real time system, and has to perform a real time processing, based on the sensor signals, which satisfies a predetermined time constraint.

Generally, in the real time system that performs signal processing for a plurality of sensor signals, the individual signals are respectively processed by independent sub-systems. That is because the sub-systems include computer resources such as central processing units (CPUs) required for the processing of individual sensor signals, and respectively run real-time operating systems (OSs) to perform allocation of resources in each sub-system. Therefore, the sensor information system that satisfies a predetermined time constraint can be easily designed and developed.

However, according to the technique whereby a separate sub-system is prepared for each signal, when an overload occurs at a sub-system that processes a specific signal, or when a default occurs in a component of a sub-system, processing of the specific signal will be delayed and not be performed within the predetermined time, or not be performed at all, regardless of whether other computer resource sub-systems that still have margin capabilities are available.

Therefore, the individual sub-systems have to have margins in functions and processing capabilities and so on to cope with overloads or defaults. However, to provide these additional capabilities, a huge amount of hardware is required, and since this increases the volume of the hardware assembly, as well as the cost and the power consumption, the commercial and technical feasibility of the sensor information system deteriorates.

Therefore, in the aeronautic field, a sensor information system is desired that requires only a comparatively small hardware assembly while a plurality of signal processing sections integrated as a single computer system. Generally, such a system has been provided as a distributed system by connecting a plurality of nodes via a network, each of which includes one or more processors, memories and input/output devices.

However, in a system configured simply by integrating a plurality of signal processing sections, when the system handles both an important signal and a less important signal, it may be occurs that the time constraint for the signal for the more important signal will be adversely affected because the system load on the process for the less important signal is increased.

Theoretically, this problem can be resolved when the entire system is operated by one real time OS to perform real time overall scheduling. However, realistically, when a system that includes multiple processors is controlled by a single OS, the scheduling becomes very complicated so that the scheduling process requires some time period. Also, it is sometimes difficult to obtain a satisfactory function that satisfies the predetermined time constraint. Furthermore, as the even more serious problem, when nodes are connected by a network that does not guarantee the strict real time processing, the real time scheduling across the nodes is impossible in the first place.

A resource allocation method using bids has been studied as a general method for allocating resources in the distributed system as disclosed, for example, in Andrew Byde, Mathias Salle and Claudio Bartolini “Market-Based Resource Allocation for Utility Data Centers”, HP Labs Technical Report HPL-2003-188, (2003).

According to a resource allocation method that uses bids, bidding is used to allocate a resource, such as CPU time, for each unit time or for each task. Each application program (hereinafter also referred to simply as an application) makes a bid, including a price, and requests the allocation of the resource, and the application that offers the highest price is selected to receive the pertinent resource and to start. The currency used for bidding is an indicator for quantifying the importance a specific application has for a user in a specific situation, and is a virtual currency that need not be linked to an actual currency. The feature of the resource allocation method using bidding is that the individual models in the system perform operations to maximize the profit obtained by subtracting the payment from the received value, so that the efficiency of the overall system is improved.

By using this bidding method, an application that processes an important sensor signal in a specific situation is permitted to offer the highest price, so that a resource can be allocated in each situation according to the importance of the signal. Further, since each node performs the bidding process for the pertinent node, the bidding process can be distributed and distributed processing for resource allocation can be easily performed.

For a simple resource allocation model, only a physical resource, such as CPU time, is a resource, an OS or a middleware program is a resource supplier, and an application program is a consumer. In the actual system, however, a more elaborate bidding may be performed based on a more complicated resource allocation model. Especially when resource allocation for a distributed system is performed using a bidding method, a more complicated resource allocation model, called a supply chain model, is sometimes employed.

The supply-chain model imitates a supply chain in the manufacturing and the distribution industries, and employs the concept of a “producer” in addition to those of the supplier and the consumer. One producer may purchase a resource, and use the resource to generate another resource for sale to another consumer or producer. In this model, data generated by the producer can also be handled as a resource in addition to a physical resource.

Because of the introduction of the concept of the producer, the bidding model can handle an application that distributes the processing to a plurality of nodes, or that performs a preprocess for data to be provided another application. It should be noted that in the system, the supplier, the consumer and the producer represent module programs provided by software, and do not represent physical persons or corporations.

Usually, as disclosed in William E. Walsh and Michael P. Wellman, “Efficiency and Equilibrium in Task Allocation Economies with Hierarchical Dependencies”, in Proceedings of the Sixteenth International Joint Conference on Artificial Intelligence (1999), the way a price for a bid is determined is more complicated when a bidding method is used that employs a supply chain model than when a method is used that employs a simple model. Especially, before a producer determines the selling price for a resource, the producer takes into consideration the purchase price of a resource required to generate the resource to be sold, and when the selling price is lower than the purchase price, the producer halts the bidding. A method for determining the selling price is known in which a complicated calculation formula is utilized so that it needs much amount of calculation. Therefore, it is general to use a multiple round bidding method in which a tentative selling price is set and a plurality of bidding rounds are performed so that the selling price is converged.

As an example bidding policy (way of the determination of the bidding price) for the producer that employs such a multiple round bidding method, at first, bids for both a resource to be sold and a resource to be purchased reflect appropriate initial prices, and the selling price and the purchase price are changed slightly depending on whether the bids for the resource being sold and the resource being purchased were successful. When a profitable result is not in the offing, i.e., the selling price is lower than the total purchase price, the producer halts the bidding. Then, by repeating the bidding round, either appropriate selling and purchase price levels for the resources may be obtained or the producer may give up the bidding, and an bidding price can be determined.

In addition to the supply chain bidding method explained above, multiple round bidding is often performed for other complicated bidding, such as multiple resource bidding for allocating a plurality of resources at the same time or in parallel.

### SUMMARY

However, when the multiple round bidding method is employed, usually, it cannot be determined how many rounds will be required for the bidding to be settled. Therefore, a characteristic of this method is that the period required to complete the bidding process can not be determined.

Since the conventional bidding method for computer resource allocation is used for the allocation of resources employed for a comparatively long term, e.g., which node should perform an application program in a non-real time system, problems concerning this characteristic have not been discussed seriously. However, when the conventional bidding method is employed for a real time system, time is required for the bidding process before the execution of an application, and the timing for the execution of the application may not satisfy the time constraint. Therefore, a real time processing for the system can not be guaranteed.

According to an aspect of the invention, there is provided a resource management apparatus including: a plurality of resource bidders; a bid manager; a repetition controller. The plurality of resource bidders are respectively provided for a plurality of application programs each of which consumes and/or supplies resources. Each of the resource bidders calculates a current bid price for each of the resources to be supplied or consumed by the associated application program within a unit time to generate current bidding information about the current bid price. The bid manager performs an allocation process to allocate the resources to the application programs through a bidding process based on the current bidding information generated by each of the resource bidders. The repetition controller controls the bid manager to repeat the allocation process until a bidding stop condition is satisfied within the unit time.

### BRIEF DESCRIPTION OF THE DRAWINGS

FIG. 1 is a diagram showing the configuration of a sensor information processing system according to one embodiment.

FIG. 2 is a block diagram for explaining a resource management portion in a software arrangement for two nodes.

FIG. 3 is a block diagram for explaining a relation between supply and consumption of a resource according to the embodiment.

FIG. 4 is a block diagram showing the arrangement of a resource bidding section and a bid management section included in a resource management apparatus.

FIG. 5 is a flowchart showing example processing performed by a bid price calculation section for a supplier.

FIG. 6 is a flowchart showing example processing performed by the bid price calculation section for a resource supplied by a producer.

FIG. 7 is a flowchart showing example processing performed by the bid price calculation section for a consumer.

FIG. 8 is a diagram for explaining that a round repetition control section permits the performance of a bidding process only a predetermined number of times.

FIG. 9 is a diagram for explaining a process unit period.

FIG. 10 is a diagram showing example bidding information for a physical resource.

FIG. 11 is a diagram showing bidding information for data.

FIG. 12 is a flowchart showing example processing performed by a successful bidder determination section for a physical resource manager, a supplier.

FIG. 13 is a flowchart showing example processing performed by a successful bidder determination section for an information display application.

FIG. 14 is a flowchart showing example processing performed by the round repetition control section.

FIG. 15 is a table showing an example wherein a bid volume for a CPU usage rate, a bid price, a contract volume and a contract price are changed as rounds continue.

FIG. 16 is a table showing an example wherein a bid volume for data, a bid price, a contract volume and a contract price are changed as rounds continue.

### DETAILED DESCRIPTION

Various embodiments according to the invention will be described hereinafter while referring to the accompanying drawings.

### 1. Hardware Configuration of System

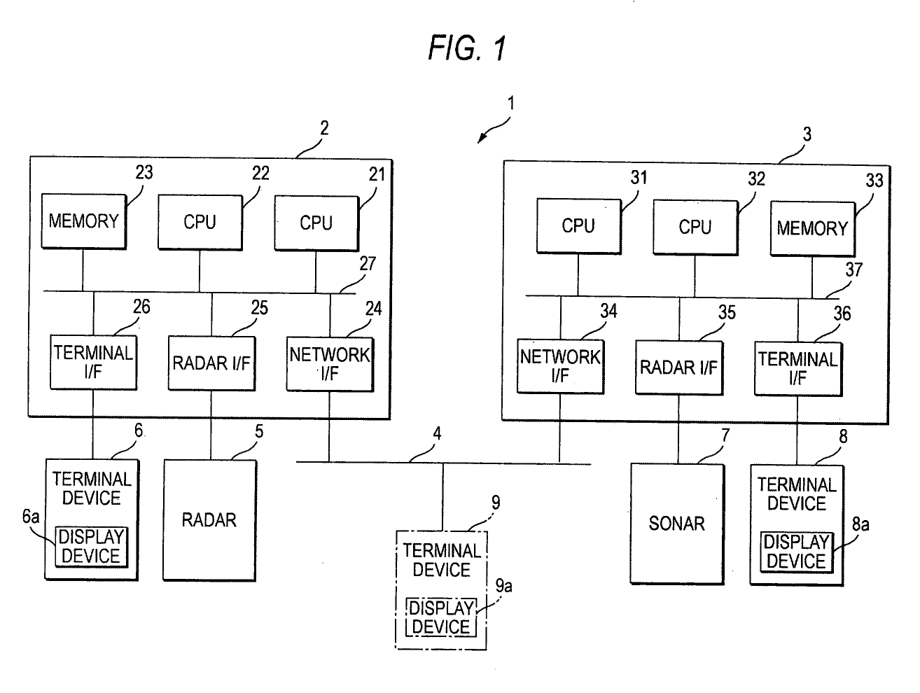

First, a hardware configuration of system according to one embodiment will be described while referring to FIG. 1.

A sensor information processing system (hereinafter referred to as a sensor information system) 1 can be employed, for example, for a ship or an airplane etc., and based on sensor signals obtained using sonar and/or radar, prepares information to be used to provide status reports for a crew on conditions therearound. Especially when a dangerous obstacle is detected, a sensor information system processes sensor information, within a predetermined time period, so that the information can be quickly provided to the crew through a screen display. Such a system is called a real time system that performs a specific process within a predetermined time period. For example, upon a sensor signal is detected, the real time system performs processing to display sensor information on the screen of a display device within one second as the predetermined time period.

The sensor information system 1 includes a plurality of nodes 2, 3, connected via a network 4. A radar 5 and a terminal device 6 are connected to the node 2. The node 2 is a computer that performs predetermined signal processing, and displays the results on the screen of a display device 6a of the terminal device 6. As will be described later, the node 2 includes a signal process application program (hereinafter also referred to simply as an application) that performs predetermined signal processing for signals individually obtained by the radar 5 and a sonar 7, and an information display application program that displays, on the display device 6a, the processing results for the signal from the radar 5.

The sonar 7 and a terminal device 8 are connected to the node 3. The node 3 is a computer that performs predetermined signal processing and displays the processing results on the screen of a display device 8a of the terminal device 8. As will be described later, the node 3 includes a signal processing application program that performs predetermined signal processing, based on signals obtained by the sonar 7 and the radar 5, and an information display application program that displays, on the display device 8a, the processing results for the signal from the sonar 7.

Further, as will be described later, a sensor signal obtained by the radar 5 is transmitted to the node 3 via the network 4, and a sensor signal obtained by the sonar 7 is transmitted to the node 2 via the network 4.

The node 2 displays radar information on the screen of the display device 6a of the display device 6, and presents to a user, in real time, information related to the sensor signal obtained by the radar 5. Similarly, the node 3 displays sonar information on the screen of the display device 8a of the terminal device 8, and presents to the user, in real time, information related to the sensor signal obtained by the sonar 7.

Therefore, in this embodiment, the nodes 2 and 3 perform information processing for the sensor information obtained by the two sensors, i.e., the radar 5 and the sonar 7, and display, in real time, the obtained radar information and sonar information on the screens of the respective display devices 6a and 8a of the terminal devices 6 and 8. For example, in the case of a ship, when the radar 5 detects an obstacle, position information for the obstacle is displayed on the screen, in real time, as sensor information.

The node 2 includes: two central processing units (hereinafter referred to as CPUs) 21 and 22; a memory 23; a network interface (hereinafter referred to as a network I/F) 24; a radar interface (hereinafter referred to as a radar I/F) 25; and a terminal device interface (hereinafter referred to as a terminal I/F) 26, all of which are connected by a bus 27.

Likewise, the node 3 includes: two CPUs 31 and 32; a memory 33; a network I/F 34; a sonar interface (hereafter referred to as a sonar I/F) 35; and a terminal I/F 36, all of which are connected by a bus 37.

The buses 27 and 37 may be wiring extended between or mounted on the boards of the nodes 2 and 3, or wiring inside the chips.

The network I/Fs 24 and 34 are interfaces for connecting the nodes 2 and 3 to the network 4, and the terminal I/Fs 26 and 36 are interfaces for connecting the nodes 2 and 3 to the terminal devices 6 and 8. The node 2 and the radar 5 are connected via the radar I/F 25, while the node 3 and the sonar 7 are connected via the sonar I/F 35.

The network 4 may be a network for which real time processing is guaranteed, or a network, such as Ethernet™, for which real time processing is not guaranteed.

While referring to FIG. 1, the radar 5 and the sonar 7 are connected to the nodes 2 and 3 via the interfaces; however, the radar 5 and the sonar 7 may incorporate network interfaces that enable their direct connection to the network 4. In this case, signals obtained by the radar 5 and the sonar 7 are respectively transmitted to the nodes 2 and 3 via the network 4.

Additionally, in the above explanation, the terminal devices 6 and 8 are connected to the nodes 2 and 3; however, instead of the terminal devices 6 and 8, or in addition to the terminal devices 6 and 8, another terminal device 9 may be connected to the network 4, as indicated by a chain line in FIG. 1. When the terminal device 9 is provided instead of the terminal devices 6 and 8, radar information and sonar information are displayed on a display device 9a of the terminal device 9, or when the terminal device 9 is provided in addition to the terminal devices 6 and 8, radar information and sonar information may be displayed either only on the display device 9a, or on the display devices 6a, 8a and 9a.

Also, the sensor information system 1 includes at least one terminal device that is provided with a display device and a keyboard and is connected to one of the nodes.

### 2. Software Configuration of System

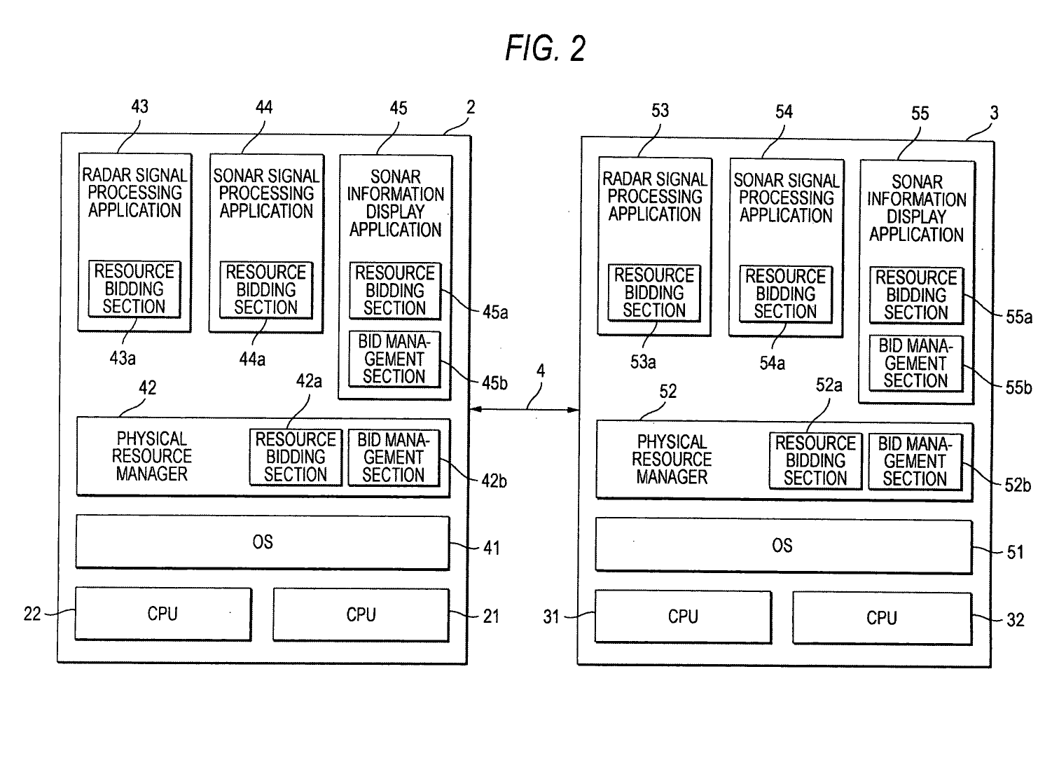

The software configurations of the nodes 2 and 3 will now be described while referring to FIG. 2.

The nodes 2 and 3 are application execution apparatuses that respectively process radar signals and sonar signals and display radar information and sonar information, and also are resource management apparatuses for managing resources, such as CPU time. That is, the nodes 2 and 3 provide resource management for real time sensor information processing, and can thus perform signal processing based on the radar signals and the sonar signals and sensor information processing for displaying, in real time, the obtained radar information and sonar information on the display devices 6a and 8a of the terminal devices 6 and 8. Thus, it can also be said that the nodes 2 and 3 are resource management apparatuses, each of which are computer provided mainly by software program that executes the application program at the respective node.

In the node 2, an OS 41 is, for example, Windows (trademark) or Linux, compatible with a multiprocessor, and is operated by CPUs 21 and 22, which are hardware. A physical resource manager 42, provided on the OS 41, manages CPU time as a resource.

Three application programs, i.e., a radar signal processing application 43, which is a radar signal processing section, a sonar signal processing application 44, which is a sonar signal processing section, and a radar information display application 45, which is a radar information display section, are operated on the OS 41 through the physical resource manager 42.

In the node 3, an OS 51 is also compatible with a multiprocessor and is operated by CPUs 31 and 32, which are hardware. A physical resource manager 52, provided on the OS 51, manages CPU time as a resource.

Three application programs, i.e., a radar signal processing application 53, a sonar signal processing application 54 and a radar information display application 55, are operated on the OS 51 through the physical resource manager 52.

Before individual application programs are executed, as will be described later, the physical resource managers 42 and 52 perform predetermined processes upon the reception of bids from applications, and manage CPU time so that the applications are executed for an amount of CPU time that is successfully bid by the applications.

In each node on which a resource management apparatus operates, either OS 41 or OS 51 manages software and hardware therein. In this embodiment, each node has two CPUs. When each node includes a plurality of CPUs, one OS that is compatible with a multiprocessor is operated, and manages resources for the entire each node. A physical resource manager, provided as middleware operated on each OS, manages physical resources. It should be noted that the physical resource manager may be provided as an internal function of the OS.

The resource management apparatus includes a plurality of resource bidding sections and a plurality of bid management sections. Specifically, the physical resource manager 42 of the node 2 includes a resource bidding section 42a and a bid management section 42b. The radar signal processing application 43 includes a resource bidding section 43a, the sonar signal application 44 includes a resource bidding section 44a, and the radar information display application 45 includes a resource bidding section 45a and a bid management section 45b. Similarly, the physical resource manager 52 of the node 3 includes a resource bidding section 52a and a bid management section 42b. The radar signal processing application 53 includes a resource bidding section 53a, the sonar signal application 54 includes a resource bidding section 54a, and the radar information display application 55 includes a resource bidding section 55a and a bid management section 55b.

That is, each of the resource bidding sections 42a to 45a, 52a to 55a are provided in the processing section that are modules supplying and/or consuming resources' (in this case, the physical resource managers 42 and 52 and the applications 43 to 45 and 52 to 55).

A resource bidding section may be provided only in some of the applications. For example, a resource bidding section may not be provided for an application that consumes not a lot of resources in order that it may be excluded from participating in bidding, while a resource bidding section may be provided for an application that consumes a lot of resources. In this case, by providing a certain margin for a capability, a resource to be consumed by an application that does not participate in bidding may be separately allocated as a fixed resource.

Either a single bid management section or a plurality of sections may be provided for each node. Further, the bid management section may serve as independent middleware or as an internal function of the OS, or may be provided inside one of the processing sections. Generally, when there is only one supplier but a plurality of consumers, the bid management section had better be arranged inside the supplier. To the contrary, when there are a plurality of suppliers and only one consumer, the bid management section had better be arranged in the consumer, because the bidding process and a communication process can be simplified. In this embodiment, since the physical resource manager (supplier) simply supplies a CPU usage rate to a plurality of applications (consumers), the bid management sections 42b and 52b are arranged in the physical resource managers 42 and 52. Further, since the sensor information display application (a consumer) simply receives a CPU usage rate and sensor information from a plurality of applications (a supplier and a producer), the bid management sections 45b and 55b are arranged in the sensor information display application. For example, in the node 2, the bid management section 42b is arranged inside the physical resource manager 42, and the bid management section 45b is arranged in the radar information display application 45.

### 3. Supply and Consumption of Resources

### 3.1 Resources

There will now be described about resources. This embodiment describes an example based on a supply chain model that handles, as resources, not only the CPU usage rate, which is the physical resource, but also data generated by the application programs.

The following are reasons why the data are also handled as the resources. Since the signal processing sections for the individual sensor signals and the information display sections for sensor information of individual types are separated, when only the CPU usage rate is employed as the resource and sensor information is not regarded as the resource, resources would be allocated while ignoring a relationship between the supply and consumption of sensor information. For example, the situation may occur in which the CPU usage rate is allocated for the sonar signal processing sections 44 and 45 while the CPU usage rate is not allocated for the sonar information display section 55. In this situation, CPU is wasted to generate sensor information which will not be utilized. In order to avoid this situation, while separating the signal processing sections from the information display sections, data, as well as the CPU usage rate, are handled as the resource.

The CPU usage rate is a ratio (%) at which a specific application employs the CPU for a unit processing time, which will be described later. For example, when the unit processing time is one second and the CPU usage rate is 30%, it means that the application can employ the CPU for 300 ms. Although the CPU usage rate (%) is employed in this embodiment, a CPU usage time (e.g., ms) may be employed. Data in this embodiment includes radar information and sonar information.

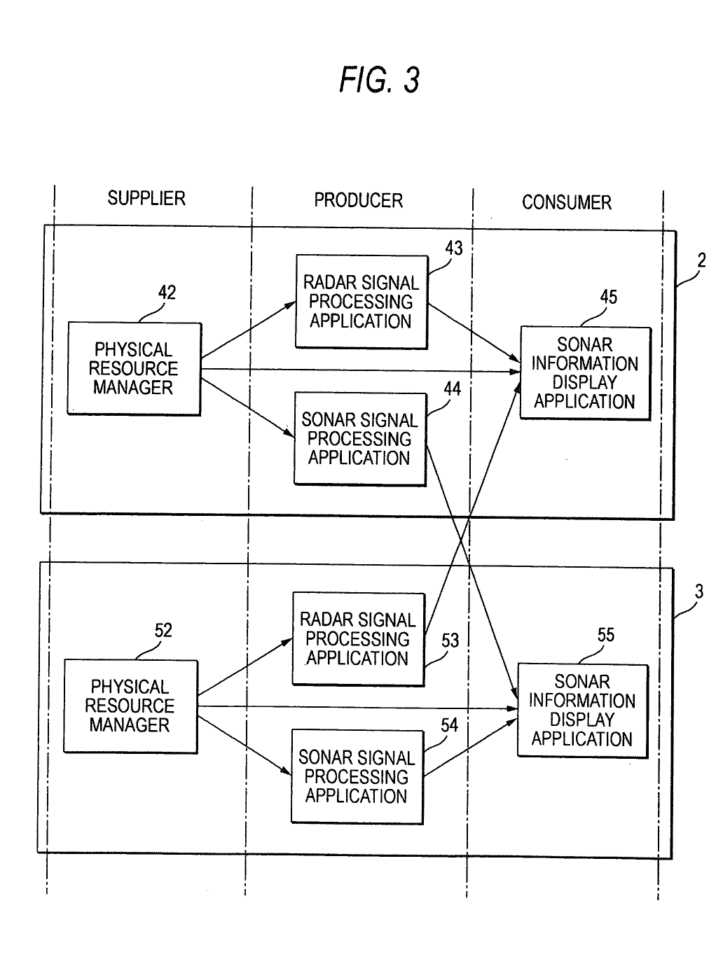

As shown in FIG. 3, in the supply chain model according to this embodiment, the physical resource managers 42 and 52 correspond to suppliers, and the radar signal processing applications 43 and 53 and the sonar signal processing applications 44 and 54 correspond to producers, and radar information display application 45 and the sonar information display application 55 correspond to consumers.

The physical resource managers 42 and 52, which are suppliers only of resources, are middlewares that manage the CPU usage rate, which is the physical resource. The physical resource managers 42 and 52 may each be incorporated as one of the corresponding OSs.

The CPU usage rate is supplied to the individual applications by the physical resource managers 42 and 52, which are the suppliers. As shown in FIG. 3, the CPU usage rate is supplied by the physical resource manager 42 to the radar signal processing application 43, the sonar signal processing application 44 and the radar information display application 45. Also, the CPU usage rate is also supplied by the physical resource manager 52 to the radar signal processing application 53, the sonar signal processing application 54 and the radar information display application 55.

The radar signal processing applications 43 and 53 and the sonar signal processing applications 44 and 54, which are the producers, consume the allocated CPU usage rate, generate predetermined sensor information, and supply the sensor information to the radar information display application 45 and the sonar information display application 55, respectively. That is, among the above applications, the sensor signal processing applications are the producers that supply sensor information.

The radar information display application 45 and the sonar information display application 55, which are the consumers, only consume the allocated CPU usage rate and the sensor information, and do not supply any resources for other applications. That is, among the above applications, the information display applications are the consumers that only consume the allocated CPU usage rate and sensor information, and do not supply resources to other applications.

Each processing section that is an application operates only when a bid is successful for all the resources to be consumed by the pertinent application. The individual signal processing sections are present in both nodes, so as to diversify the processing load imposed on the nodes 2 and 3. Accordingly, when one of the signal processing sections on either node is operated, sensor information is generated. For example, the radar information display application 45 is initiated so long as the CPU usage rate is allocated, and the radar information display application 45 receives the radar information from either the radar signal processing section 43 or 53.

### 3.2 Resource Supplying Method

A resource supplying method will now be described.

The signal processing application actually supplies sensor information, which is one of the resources in this embodiment, to the sensor display application. As the supply of sensor information, for example, the radar signal processing application 43 transmits radar information obtained by signal processing to the radar information display application 45.

On the other hand, the supply of the CPU usage rate is a conceptual matter, so that no supply is explicitly performed, and an application program is designed to execute using the CPU only when a bid for the CPU usage rate is successful.

When the actual behavior of an application is not trusted, e.g., when an application may be prepared by a third party, the physical resource manager may monitor the state of the OS to determine whether the application actually employs the CPU precisely at the CPU usage rate that is successfully bid. When the application is employing the CPU at a CPU usage rate that exceeds the CPU usage rate that is successfully bid, the physical resource manager can forcibly terminate the application using an interrupt process, and can force the application to keep the CPU usage rate that is allocated.

The resource allocation process described above is performed through bidding by the resource management apparatus.

### 3.3 Resource Allocation Determination Method

(a) CPU Usage Rate

First, an explanation will be given for a method for determining the CPU usage rate, which is a physical resource, i.e., a consumption volume of a resource and a supply volume of the resource. In each process unit time, each application calculates the CPU usage rate necessary for the application, i.e., the consumption volume, and clearly states or determines the CPU usage rate. For this determination, an application creator may explicitly write a numerical value or a calculation expression in the source code of the application, or a compiler may determine the CPU usage rate during compilation. As another method, when each application is executed, the application may measure consumption volume by monitoring the states of the physical resource manager and the OS, and may employ the measurement history to estimate a future usage rate for the physical resource.

The physical resource manager calculates the rate at which a resource can be supplied to an application. In this embodiment, a value obtained by subtracting, from the rate (%) relative to the total usage period for all the CPUs, operating margins for the OS and middleware and the safety margin is the rate at which a resource can be supplied to the application. In this embodiment, each node employs the supply volume 180%, which is obtained by subtracting a margin of 20% from 200% for two CPUs.

(b) Sensor Information

An explanation will be given for a method for determining the consumption volume and the supply volume for sensor information.

For sensor information that is a resource other than a physical resource, the consumption volume and the supply volume are designated when the creator of an application explicitly writes a numerical value or a calculation expression, as part of the logic for an application, in the source code of the application.

For example, since during a predetermined sampling cycle the sonar signal processing application receives a sensor signal from the sonar 7, which is a sensor, a transfer rate for sensor signals, such as a bit rate, becomes the consumption volume. Further, since the sonar signal processing application performs predetermined signal processing and supplies sensor information to the sonar information display application, the transfer rate for the sensor information, such as a bit rate, becomes the supply volume.

Additionally, as will be described later, the consumption volume and the supply volume are changed based on a bid, and, the CPU usage rate is also changed in accordance with the transfer rate of sensor signals supplied to the node. For example, in the node 2, the CPU usage rate is changed in accordance with the transfer rate for sensor signals supplied to the node 2, and similarly, in the node 3, the CPU usage rate is changed in accordance with the transfer rate for sensor signals supplied to the node 3. Therefore, the total rate at which sensor signals are output by the radar 5, for example, is shared by the nodes 2 and 3, and each node needs a CPU usage rate consonant with the shared transfer rate of the sensor signals.

(c) Resource Allocation Notification

The consumption volume or the supply volume, which is determined or designated by each processing section in the above described manner, is notified the resource bidding section that is arranged inside the processing section. The resource bidding section joins the bidding for the consumption volume or the supply volume that is designated or determined to the bid management section.

### 4. Configuration of a Resource Management Apparatus

### 4.1 Resource Management Apparatus

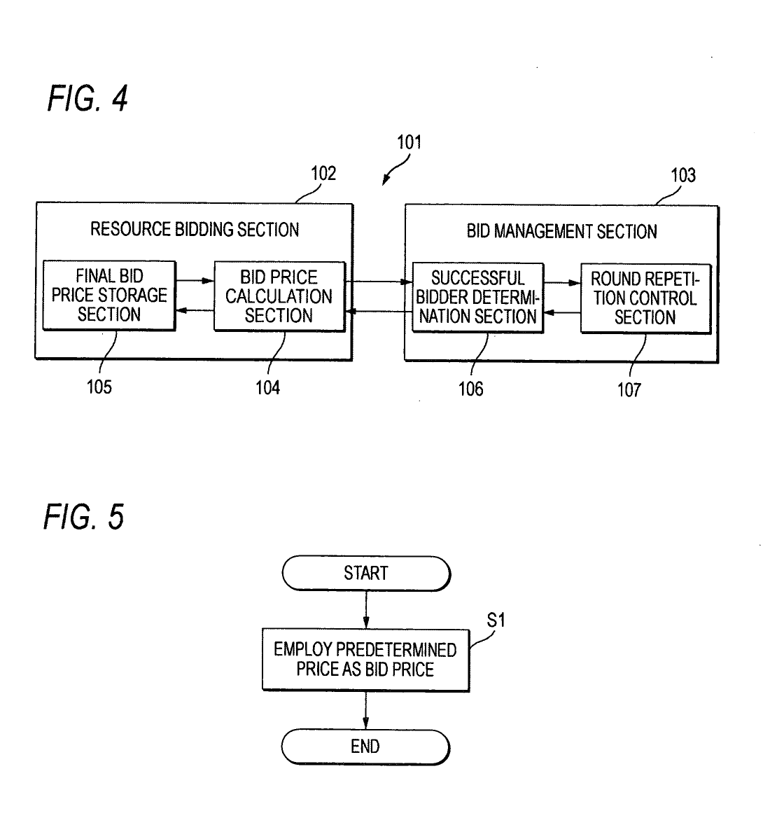

As shown in FIG. 4, in this embodiment, a resource management apparatus 101 includes a plurality of resource bidding sections 102 and a plurality of bid management sections 103. In FIG. 4, the transmission of data is shown between one resource bidding section 102 and one bid management section 103 in order to show the relationship of the resource bidding section and the corresponding bid management section of each application.

For example, for the node 2, to bid for a CPU usage rate, the resource bidding sections 42a, 43a, 44a and 45a correspond to the resource bidding section 102, and the bid management section 42b corresponds to the bid management section 103. To use data to bid for radar information, the resource bidding sections 43a (and 53a) and 45a of the radar signal processing section 43 correspond to the resource bidding section 102, and the bid management section 45b corresponds to the bid management section 103.

The resource bidding section 102 includes a bid price calculation section 104 and a final bid price storage section 105, and the bid management section 103 includes a successful bidder determination section 106 and a round repetition control section 107.

The details of operations performed by the individual components of the resource management apparatus 101 will now be described.

### 4.2 Resource Bidding Section

First, the processing performed by the resource bidding section 102 will be described.

The resource bidding section 102 offers a bid, to the bid management section 103, for a resource for which the consumption volume or the supply volume is obtained by employing the previous determination. That is, the resource bidding section 102 provides its own resource information. In order to offer a bid, the resource bidding section 102 makes a plurality of bids to the bid management section 103, i.e., during a plurality of rounds.

At each round, the bid price calculation section 104 calculates a bid price as a price for a bid.

For this calculation, the bid price calculation section 104 supplies a price that permits the profit of the processing section to be maximized through the selling or through the purchase of the resource at this price.

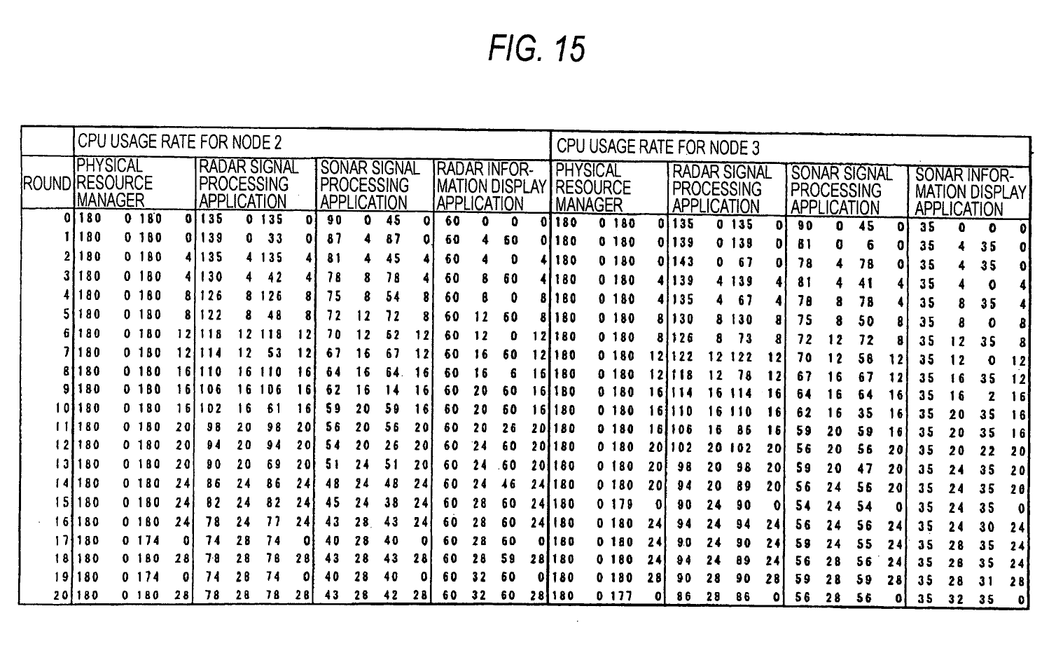

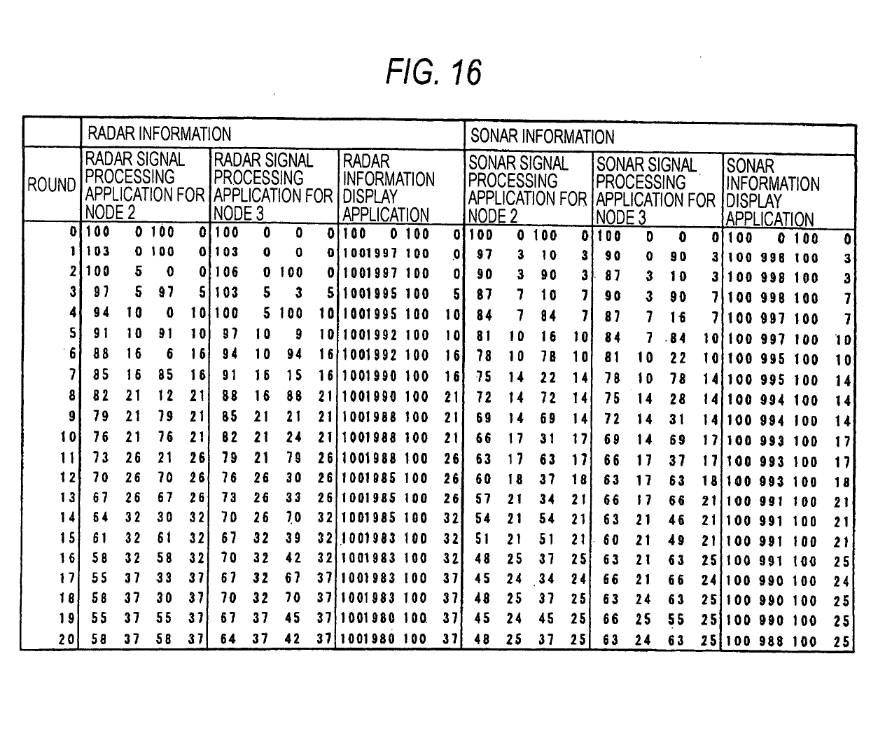

Specific operations of the bid price calculation section 104 differ, depending on whether a processing section serves as a supplier, a producer or a consumer. Individual cases will now be described. FIGS. 15 and 16 are tables wherein bid volume, bid price, contract volume and contract price for a CPU usage rate and data are changed as each round has finished. In FIG. 15, bid volume, bid price, contract volume and contract price for a CPU usage rate are shown for the individual processing section of the nodes 2 and 3, and in FIG. 16, bid volume, bid price, contract volume and contract price for data are shown for each of the processing sections. Beginning at the left, the numerals entered in the columns in the tables in FIGS. 15 and 16 reflect bid volume, bid price, contract volume and contract price. The operation performed by the bid price calculation section 104 will now be described while referring to FIGS. 15 and 16.

(a) Supplier Case

A supplier does not have to hold back on the sale of available resources. Regardless of whether the price is low, a supplier need only establish a bid price that will ensure as many resources as possible will be sold. Therefore, in each instance, the bid price calculation section 104 of a supplier simply returns a fixed bid price. In this embodiment, it is assumed that the physical resource managers 42 and 52, which are suppliers, always offer as a bid price for the CPU usage rate a price of 0. Thus, for a supplier, a final bid price storage section is not required.

FIG. 5 is a flowchart showing example processing performed by the bid price calculation section 104 of a supplier. The bid price calculation section 104 constantly employs as a bid price a predetermined price, in this case, for example, a fixed value of “0” (step S1).

(b) Producer Case

A producer may purchase at a high price a resource to be used for the generation of another resource that can be sold at a higher price. On the other hand, when an apparent selling price is lower than the purchase price, a producer has to abandon the attempt to make a deal. Therefore, the bid price calculation section 104 of a producer performs the following processing.

For the first round, the bid price calculation section 104 employs, as a bid price, a price stored in the final bid price storage section 105. It should be noted that an initial price of 0 is stored in the final bid price storage section 105. For the second and following rounds, the bid price calculation section 104 adjusts the bid price, depending on whether the bid for the preceding round is successful.

To obtain a resource to supply (e.g., radar information when the producer is the radar signal processing application 43), the bid price calculation section 104 joins in the bidding by employing, as a bid price (a selling price), a total predicted price for bid prices (purchase prices) for a resource to be consumed (e.g., a CPU usage rate when a producer is the radar signal processing application 43). For the calculation of a predicted bid price (a purchase price) for a resource that the processing section consumes, the bid price calculation section 104 employs a method for calculating the total of the contract prices for the resources during the previous round (the contract price is not necessarily a price at which a specific processing section won, for when the bid of this processing section is not accepted, a contract price for another processing section is employed). For a resource to be consumed, the predicted bid price is calculated by increasing the resource bid price, by adding a predetermined value, when the resource was not traded during the preceding round.

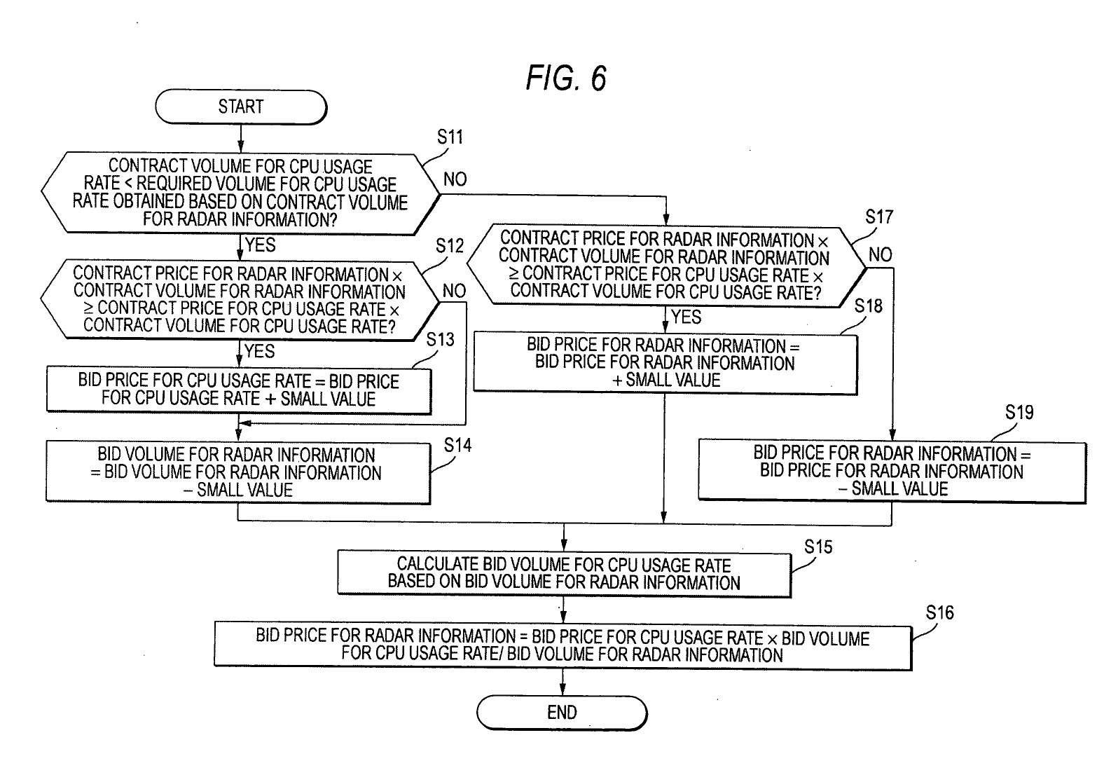

FIG. 6 is a flowchart showing the processing performed by the bid price calculation section 104 for a resource supplied by a producer. Immediately before each round in a bidding process is initiated, the radar signal processing application 43 performs the processing as shown in FIG. 6, and determines a bid price for each round. The resultant, determined bid price is supplied to the bid management section 103.

First, the bid price calculation section 104 determines whether the preceding contract volume for the CPU usage rate is smaller than a required volume for the CPU usage rate obtained through a calculation based on a contract volume for radar information (step S11). When the preceding contract volume for the CPU usage rate is smaller than the required CPU usage rate obtained through the calculation based on the contract volume for the radar information, (Yes in step S11). Then, the bid price calculation section 104 determines whether a product for the contract price of the radar information and the contract volume for the radar information is equal to or greater than a product for the contract price for the CPU usage rate and the contract volume for the CPU usage rate (step S12).

In the example shown in FIGS. 15 and 16, the radar signal processing application 43 requires a CPU usage rate of “135” to generate radar information of “100”.

The decision at step S11 is YES when the contract volume for the CPU usage rate is “48” in FIG. 15, at round 5 of the radar signal processing application 43 for the node 2, while in FIG. 16, the contract volume for the radar information is “91”. In this case, the CPU usage rate obtained based on the contract volume of “91” for the radar information is “123”, and the contract volume for the CPU usage rate is equal to or greater than “48”.

When the decision at step S12 is YES, i.e., when a product for the contract price of radar information and the contract volume for the radar information is equal to or greater than the product of the contract price of the CPU usage rate and the contract volume for the CPU usage rate, it is assumed that a deal is profitable, i.e., the selling price is higher than the purchase price, and program control advances to step S13. In other words, in this case, for example, at round 19 for the radar signal processing application 43 for the node 2 in FIG. 15, the contract volume for the CPU usage rate is “74”, the contract price is “0” and a product of the two is “0”, while the contract volume for the radar information is “55” in FIG. 16, the contract price is “37” and the product of the two is “2035”.

When the decision at step S12 is YES, the CPU usage rate for the radar signal processing application 43 may be increased. Thus, the bid price calculation section 104 increments the bid price for the CPU usage rate using a predetermined small value (d1) (in this case, “4”) (step S13). This corresponds to the case wherein, in FIG. 15, the bid price is incremented following round 19, from “74” to “78”, for round 20 of the radar signal processing application 43 for the node 2.

When the decision at step S12 is NO, the bid price calculation section 104 decrements the bid volume for radar information by a predetermined small value (d2) in order to reduce the bid volume for the radar information in the radar signal processing application 43 (step S14). When the decision at step S12 is NO, it is assumed that a deal is not profitable.

As shown in FIG. 15, at round 18 of the radar signal processing application 43 for node 2, the contract volume for the CPU usage rate is “78”, the contract price is “28” and a product of the two is “2184”. On the other hand, as shown in FIG. 16, the contract volume for the radar information is “30”, the contract price is “37” and a product of the two is “1110”. In this case, from round 18 to 19, the radar signal processing application 43 reduces the bid volume for radar information from “58” to “55”.

Following this, the bid price calculation section 104 employs the bid volume for radar information and calculates the altered bid volume for the CPU usage rate (step S15). Through the calculation performed at step S15, the CPU usage rate required for generating radar information can be obtained.

Then, the bid price calculation section 104 divides, by the bid volume for radar information, the product of the bid price and the bid volume for a CPU usage rate, and obtains the bid price for the radar information (step S16).

When the decision at step S11 is NO, i.e., when the CPU usage rate required for processing radar information is obtained, the bid price calculation section 104 determines whether the product of the contract price for the radar information and the contract volume for the radar information is equal to or greater than the product of the contract price for the CPU usage rate and the contract volume for the CPU usage rate (step S17).

The decision at step S1 is NO when, as shown in FIG. 15, at round 18 for the radar signal processing application 43 of the node 2, the contract volume for the CPU usage rate is “78”, while in FIG. 16, the contract volume for radar information is “30”. In this case, “41” is the required CPU usage rate that corresponds to the contract volume of “30” for radar information, and the contract volume for the CPU usage rate is smaller than “78”.

When the decision at step S17 is YES, i.e., when a deal is profitable, the bid price calculation section 104 uses a predetermined small value (d3) to increment the bid volume for radar information, so that the bid volume for radar information is raised for the radar signal processing application 43 (step S18).

When the decision at step S17 is NO, i.e., when a deal is not profitable, the bid price calculation section 104 uses a predetermined small value (d4) to increment the bid volume for radar information, so that the bid volume for radar information is raised for the radar signal processing application 43 (step S19).

Thereafter, the bid price calculation section 104 performs the processes at steps S15 and S16.

(c) Consumer Case

Within a range of up to the upper limit purchase price that is consonant with the importance of an application for a specific aspect, i.e., in a situation wherein a consumer purchases a resource to be consumed and performs the processing. The importance level of each application varies in accordance with the situation. An application creator may write an upper limit price into the source code of an application, an application may recognize an aspect and calculate an upper limit price, or a user may employ a terminal directly or indirectly to designate one.

In this embodiment, assuming that radar information is more important than sonar information; the upper limit price of the total purchase price for resources for the radar information display application is regarded as “200000”, and the upper limit price of the total purchase price for resources for the sonar information display application is regarded as “100000”; and when a resource can not be purchased at a price within this range, purchase of the resource during a unit time is terminated. Therefore, bidding is performed in consonance with the importance level of a sensor signal.

For the first round, the bid price calculation section 104 employs, as a bid price, a price stored in the final bid price storage section. It should be noted that the initial price of “0” is stored in the final bid price storage section. For the second and following rounds, whether the bid price calculation section 104 controls the bid price depends on whether the bid was successful during the preceding round.

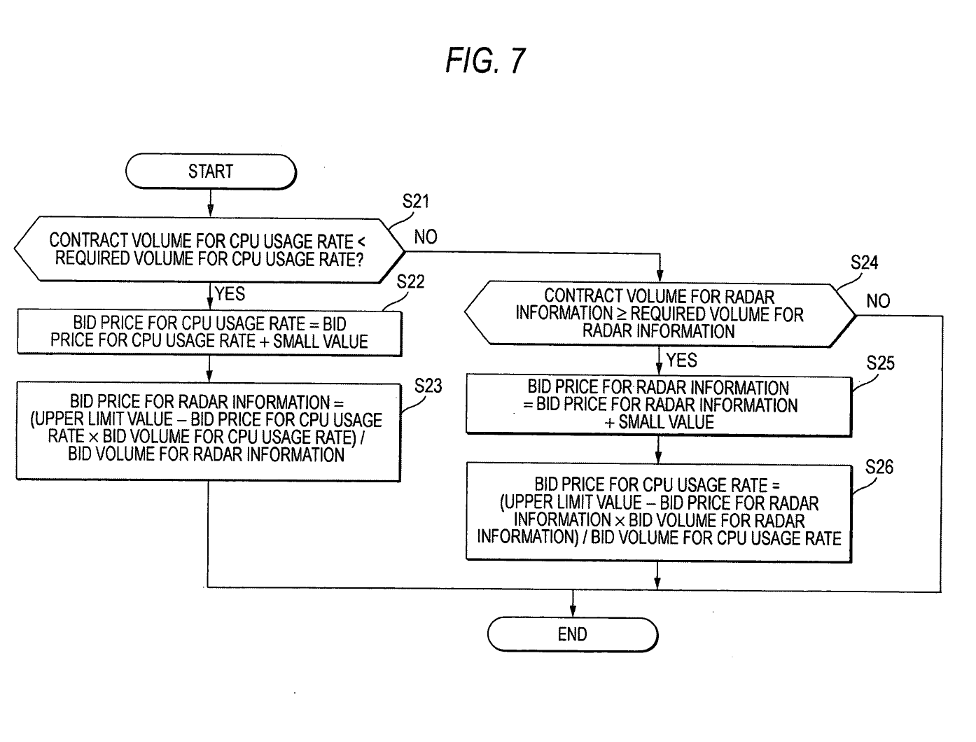

FIG. 7 is a flowchart showing example processing performed by the bid price calculation section 104 of a consumer. First, the bid price calculation section 104 determines whether the contract volume for a CPU usage rate is smaller than a required volume for the CPU usage rate (step S21).

The required volume is a fixed value in this case. For example, as shown in FIG. 15, the required volume for the CPU usage rate for the radar information display application in node 2 is “60”, and as a result, the contract volume for the CPU usage rate is “60”.

When the decision at step S21 is YES, i.e., when the contract volume for the CPU usage rate is smaller than the required volume for the CPU usage rate, the bid price calculation section 104 increments the bid price for the CPU usage rate by a predetermined small value (d5) (step S22).

Sequentially, then, the bid price calculation section 104 subtracts, from the upper limit value, a value obtained by multiplying the bid price for the CPU usage rate by the bid volume for the CPU usage rate. And the bid price calculation section 104 divides the resultant value by the bid volume for radar information, and acquires a bid price for radar information (step S23). That is, the bid price for radar information is determined, so that the sum of a value obtained by multiplying the bid volume for the CPU usage rate by the bid price for the CPU usage rate and a value obtained by multiplying the bid volume for the radar information by the bid price for the radar information does not exceed the upper limit value.

When the decision at step S21 is NO, i.e., when the contract volume for the CPU usage rate is equal to or greater than the required volume for the CPU usage rate, the bid price calculation section 104 determines whether the contract volume for the radar information is equal to or greater than the required volume for the radar information (step S24).

The required volume for the radar information is a fixed value in this case. For example, the required volume for the CPU usage rate for the radar information display application 45 for the node 2 is “100”, and as a result, as shown in FIG. 16, the contract volume is “100”.

When the decision at step S24 is YES, i.e., when the contract volume for the radar information is equal to or greater than the required volume for the radar information, the bid price calculation section 104 increments the bid price for the radar information by a predetermined small value (d6) (step S25). This is because a bid price for the radar information is higher, and accordingly, a bid price for the CPU usage rate is lower.

Specifically, the bid price calculation section 104 subtracts, from the upper limit value, a value obtained by multiplying the bid price for radar information by bid volume for the radar information, divides the resultant value by bid volume for the CUP usage rate, and obtains the bid price for the CPU usage rate (step S26). That is, the bid price for the CPU usage rate is determined, so that a sum of a value that is obtained by multiplying the bid volume for the CPU usage rate by the bid price for the CPU usage rate and a value that is obtained by multiplying the bid volume for the radar information by the bid price for radar information does not exceed the upper limit value.

### 4.3 Bid Management Section

The processing performed by the bid management section 103 will now be described.

The bid management section 103 employs bidding by the individual resource bidding sections 102, i.e., bidding information used to determine which processing section was successful in bidding for a resource, and transmits bidding result information to the resource bidding sections 102 of the individual processing sections. The bidding result information includes information as to whether the bid made by a pertinent processing section was accepted and information about a contract price (this price is not always that bid by a specific processing section, and when a bid submitted by that processing section was not successful, the bid price of another processing section is the contract price).

Upon receiving the bidding result information, the resource bidding section 102 of each processing section performs an operation for a process unit period. The processing section that won a bid for a resource to be consumed performs an operation for the consumption of the resource. Generally, during the process unit period, a processing section that during a specific process unit period cannot win any bids for resources to consume does not perform a process and enters a so-called sleep mode. On the other hand, a processing section that can perform some operation, even though it could not win a bid for part of the resources to be consumed, performs a corresponding operation. A processing section that can not win a bid for a resource to supply does not supply the resource during the next process unit period.

When a resource is a CPU usage rate that is a physical resource, during the next process unit period an application that won a bid for the CPU usage rate performs a predetermined operation, using a CPU, during a period obtained by bidding. When a resource is data other than a physical resource, an application that won a bid for data receives data equivalent to the contract volume that was accepted.

For example, the radar signal processing application 43 performs a process during a CPU period obtained as a result of bidding. As described above, when bids (by either the radar signal processing application 43 or 53) for both the CPU usage rate and the data were accepted, the radar information display application 45 performs the processing using data obtained through the bidding performed during a CPU period, which was also obtained through bidding.

(a) Round Management

In this embodiment, the number of rounds, i.e., the number of repetitions, is a bidding end condition, and the bidding processes performed are controlled so that they do not exceed a predetermined number of rounds. That is, the round repetition control section 107 of the bid management section 103 counts the number of rounds in each process unit period, and monitors the system so that a bid winner determination process is repeated only a predetermined number of times.

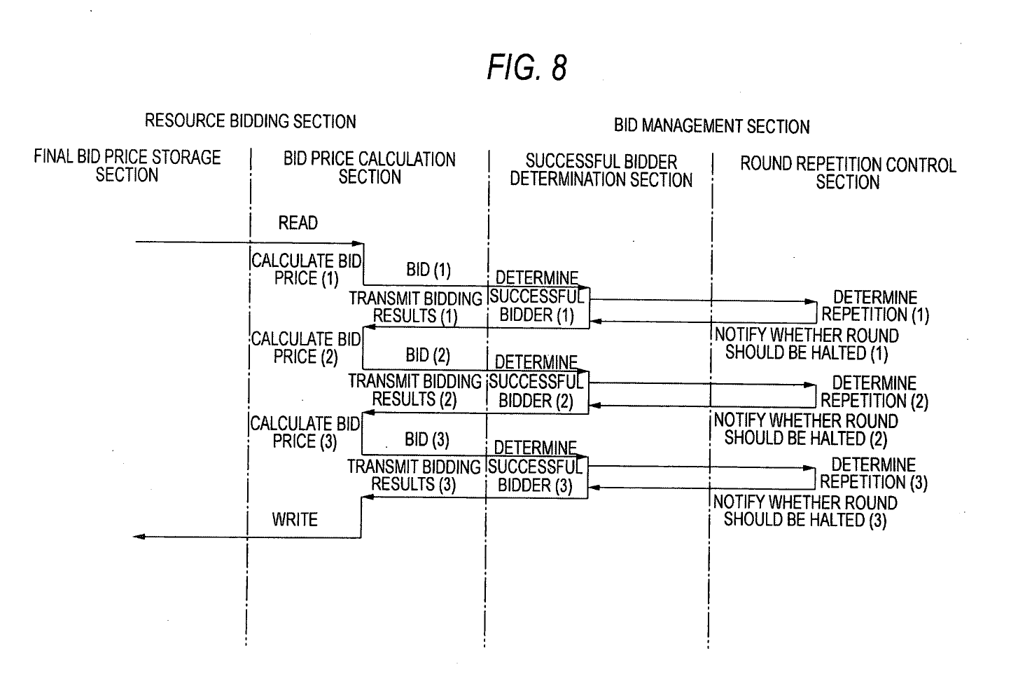

FIG. 8 is a diagram for explaining the processing performed by the round repetition control section 107 to permit the performance of the bidding process only a predetermined number of times.

As shown in FIG. 8, first, the resource bidding section 102 reads the preceding, final bid price from the final bid price storage section 105, calculates a bid price using the preceding, final bid price, and tenders a bid (bid (1)). In response to this bid, the bid management section 103 performs bidding to determine a successful bidder (contract volume (1)). In response to the contract volume (1), the resource bidding section 102 calculates the next (i.e., the second) bid price, and again tenders a bid (bid (2)). In response to this bid (2), the bid management section 103 also performs the bidding process, and determines a successful bidder (contract volume (2)). Sequentially, in response to this bidding, the resource bidding section 102 again offers a bid (bid (3)), and accordingly, the bid management section 103 again performs the bidding process. It should be noted that for the first and the second processes the round repetition control section 107 does not transmit an end notification, which will be described later, to the successful bidder determination section 106.

In this manner, the round repetition control section 107 employs, as one round, the bidding results relative to one bidding, and when a bid is received or bidding results are output, increments the round count by one.

When the round count reaches a predetermined number, the round repetition control section 107 detects this and transmits this detection result as an end notification to the successful bidder determination section 106. The successful bidder determination section 106 then transfers the end notification to the resource bidding section 102. Upon receiving the end notification, the bid price calculation section 104 of the resource bidding section 102 ceases the performance of bid calculations, and stores the final bid price included in the bidding results information to the final bid price storage section 105.

As described above, since the bidding processes can be repeated no more than a predetermined number of times, with the round count employed as the end condition for such repetitions, the resource management apparatus of this embodiment can terminate the performance and thus limit the employment of bidding processes to a predetermined time period.

(b) Process Unit Periods

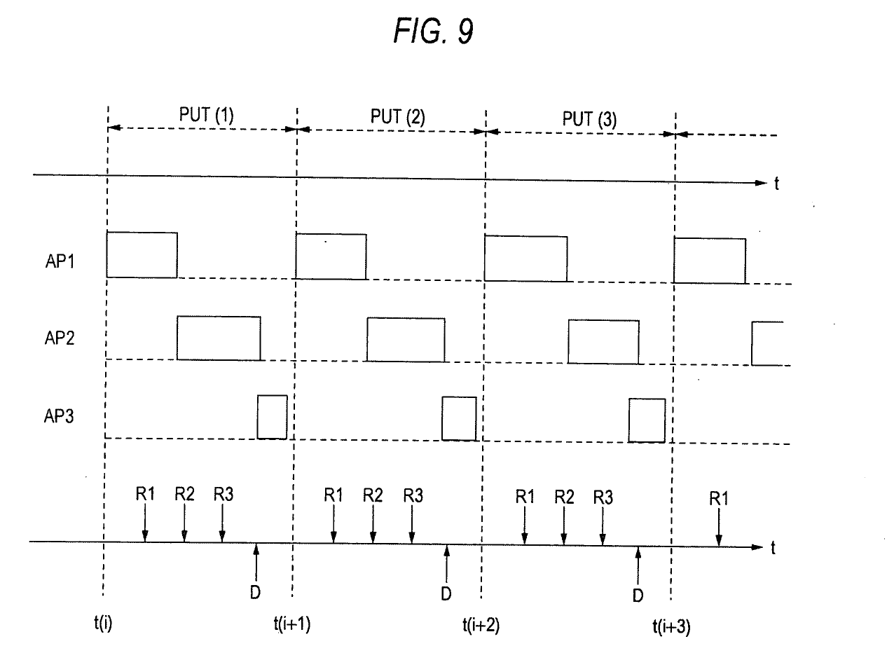

Process unit periods will now be described. In this embodiment, the application is executed during each process unit period. FIG. 9 is a diagram for explaining process unit periods, and shows the execution of three applications for node 2, i.e., the radar signal processing application 43, the sonar signal processing application 44 and the radar information display application 45. In the example in FIG. 9, three applications AP1, AP2 and AP3 are executed during periods consonant with CPU usage rates that are respectively allocated for the process unit periods.

During a process unit period, allocation of a resource for each application for the next process unit period is determined by bidding. During a process unit period (PUT1), from time t(i) to time t(i+1), a bidding process is repeated a predetermined number of times, in the above described manner, and successful bidders are finally determined. In this embodiment, this predetermined repetition number of times is three. In accordance with the bidding results determined in this manner, individual applications are performed at the allocated CPU usage rates. As shown in FIG. 9, the CPU usage rates for the individual applications during a process unit period (PUT2), from time t (i+1) to time t (i+2), are determined through bidding processes performed during the process unit period (PUT1).

In FIG. 9, the first bidding (R1), the second bidding (R2), and then the third bidding (R3) are performed in order. After the three bidding processes have been completed, the bidding contents are finally determined at timing D. In accordance with the bidding results, individual applications are performed, at the allocated CPU usage rates, during the following process unit period.

Similarly, the CPU usage rates for the individual applications during a process unit period (PUT3) are determined by bidding processes performed during the process unit period (PUT2) In the same manner, the CPU usage rates to be allocated to the applications in the following process unit period are determined by the bidding processes performed during the current process unit period.

(c) Successful Bidder Determination Section

When the bid management section 103 receives bid information, the successful bidder determination section 106 determines which application resource bid was successful.

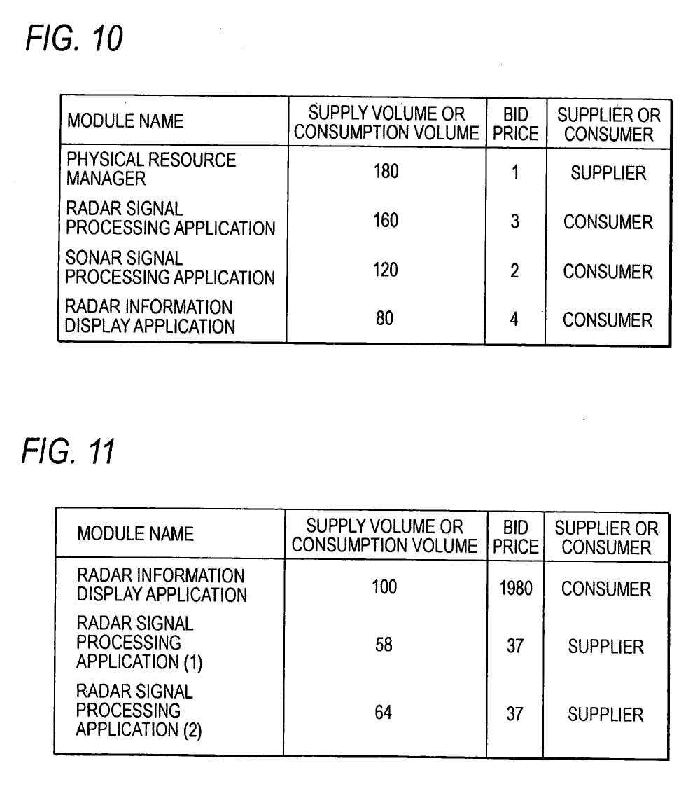

The operation of the successful bidder determination section 106 will now be explained by employing an example wherein the bid management section 42b of the physical resource manager 42 of node 2 offers a bid for the contents shown in FIG. 10. FIG. 10 is a diagram showing example bid information for physical resources.

The bid information includes a module information, a supply volume or a consumption volume, a bid price and information as to whether a processing section is a supplier or a consumer. The module name indicates a processing section, and can be represented not only by using a character string shown in FIG. 10, but also by a numerical value, such as a process number. The supply volume or the consumption volume is designated using a numerical unit defined by each resource to represent how much of the resource is to be consumed or supplied. In FIG. 10, the CPU usage rate is designated by using a percentage. The bid price is designated using a virtual currency to represent the cost to consume or to supply a resource. The unit price for each resource may be designated, or the total price (a value obtained by multiplying a quantity by a unit price) may be designated. In FIG. 10, a unit price is shown for a CPU usage rate.

The operation of the successful bidder determination section 106 will now be described.

First, an explanation will be given for the operation of the successful bidder determination section 106 performed when one supplier and a plurality of consumers engage in the bidding process for the CPU usage rate, i.e., when the bid management section 42b of the physical resource manager 42 in this embodiment performs a bidding process. In this case, in response to bids from the consumers, resources are allocated to the consumers beginning with the one that offered the highest bid price, until the supply volume reaches zero, or until a bid price of the consumers is lower than a bid price of the supplier.

At this time, the contract price is a higher price than either the highest bid price of those offered by the consumers, to which a resource that fully satisfies the value for a bid volume was not allocated, or a bid price of the supplier.

As an example, when bidding shown in FIG. 10 is performed, the supply volume of 180% for the physical resource manager is allocated as the consumption volume for each application. In this case, in order, beginning with the highest bid price, a usage rate of 80% is allocated to the radar information display application 45. Then, the remaining supply volume of 100% is allocated relative to the rate of 160% for the radar signal processing application. Further, the contract price is “3” because the bid price “3” for the radar signal processing application (to which a resource that fully satisfies the bid volume, “160%”, is not allocated) is higher than the bid price “0” for the physical resource manager.

The operation of the successful bidder determination section 106 will be explained by employing an example wherein the bid management section 45b of the radar information display application 45 of the node 2 performs the bidding process for the contents shown in FIG. 11. FIG. 11 is a diagram showing example bidding information for data.

As shown in FIG. 11, the consumption volume of the radar information display application 45 is “100”%, and this means the radar information display application 45 can not perform a display process unless 100% of the data is received. The supply volume of the radar signal processing application 43 of the node 2 is “58”%, which indicates that “58” is the maximum value of the rate (%) at which the radar signal processing application 43 can process and supply radar information. The maximum value “58” is a value determined based on the CPU usage rate available for the radar signal processing application 43 in node 2, and according to this setup value, the radar signal processing application 43 is permitted to process 58% of 100% of the radar information. Similarly, the supply volume for the radar signal processing application 53 of node 3 is “64”, which indicates that “64” is the maximum value of the rate (%) at which the radar signal processing application 53 can process and supply radar information. This maximum value “64” is a value determined based on the CPU usage rate available for the radar signal processing application 53 in node 3, and according to this setup value, the radar signal processing application 53 is permitted to process 64% of 100% of the radar information.

The bid price “1980” for the radar information display application 45 indicates that “1980” is the maximum bid price for the radar information display application 45. The bid prices of the radar signal processing application 43 of node 2 and the radar signal processing application 53 of node 3 are both “37”, which indicates that “37” is their lowest bid price.

Since the bid price is the unit price for the unit CPU usage rate, the CPU usage rate need not be considered in a comparison of bid prices. However, the total price is employed as a bid price, and the successful bidder determination section 106 needs to divide the bid price by the CPU usage rate to obtain a unit price and compare the unit prices thus obtained to determine a successful bidder.

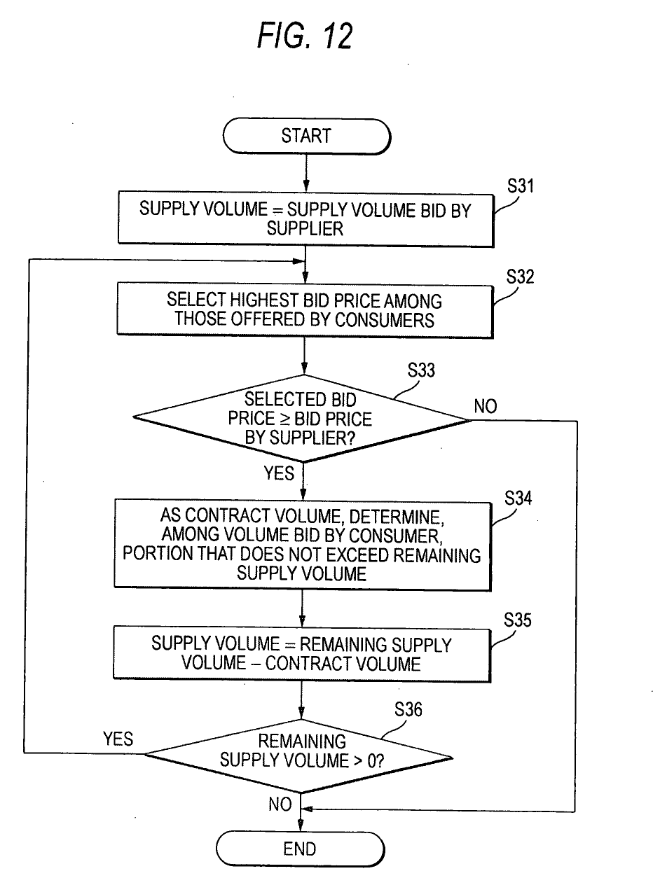

FIG. 12 is a flowchart showing example processing performed by the physical resource successful bidder determination section 106, which is a supplier. In this case, node 2 is employed.

First, the successful bidder determination section 106 employs, as a supply volume, a supply volume determined by the supplier, i.e., a supply volume included in bidding information provided by the supplier (step S31).

The successful bidder determination section 106 selects a bid offering the highest price from among bidding information received from resource consumers (step S32). In the example shown in FIG. 10, the radar information display application 45 is selected.

The successful bidder determination section 106 determines whether the bid price of a specific consumer is equal to or higher than a bid price presented by the supplier (step S33). In the example in FIG. 10, since the bid price provided by the physical resource manager 42, which is a supplier, is “1”, and the bid price of the radar information display application 45, which is a consumer, is “4”, the decision at step S33 is YES, and the successful bidder determination section 106 advances to step S34.

When the bid price of the consumer is lower than the bid price of the supplier, the decision at step S33 is NO, and the successful bidder determination section 106 terminates the processing.

At step S34, as a contract volume, the successful bidder determination section 106 determines, from among the bids provided by the consumers, a volume that does not exceed the remaining supply volume. In the example in FIG. 10, since the consumption volume of 80 for the radar information display application 45 can be subtracted from the supply volume of 180, the consumption volume of 80 that does not exceed the supply volume is determined as a contract volume.

Sequentially, the successful bidder determination section 106 calculates the remaining supply volume, i.e., subtracts the contract volume from the remaining supply volume to obtain the resultant supply volume (step S35). In the example in FIG. 10, the contract volume of 80 is subtracted from the supply volume of 180, and the remaining supply volume of 100 is obtained.

Thereafter, the successful bidder determination section 106 determines whether the remaining supply volume is equal to or smaller than 0 (step S36).

When the remaining supply volume is greater than 0, the decision at step S36 is YES, and the processing is returned to step S32. When the remaining supply volume is equal to or smaller than 0, the decision at step S36 is NO, and the processing is terminated.

At step S32, the processes at steps S32 to S36 are repeated for bids offered by consumers other than the successful bidder.

The processes at steps S31 to S36 are repeated a predetermined number of times (three times in the embodiment). The processing at steps S31 to S36 corresponds to one round.

As described above, when a plurality of resource consumption programs that consume a resource are included in a plurality of application programs, the bid management section 103 performs the resource allocation process so as to preferentially allocate a resource to a program that offers a bid price higher than that offered by the other programs.

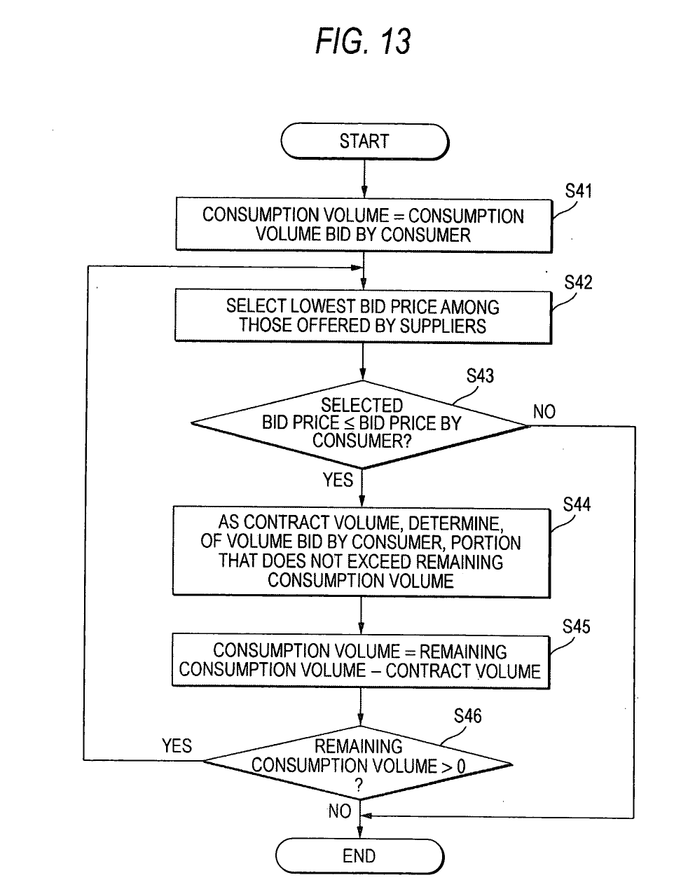

On the other hand, when a plurality of suppliers and one consumer are engaged in the bidding process for sensor information, i.e., in the case for the bid management section 45b of the radar information display application 45, “supply” is replaced with “consume”, and “high” is replaced with “low” in the processing in FIG. 12 for the operation of the successful bidder determination section 106. FIG. 13 is a flowchart showing example processing performed by the successful bidder determination section 106 for an information display application.

First, the successful bidder determination section 106 employs, as a consumption volume, a consumption volume determined by the consumer, i.e., a consumption volume included in bidding information provided by the consumer (step S41).

The successful bidder determination section 106 selects a bid representing the lowest price from among bidding information received from resource suppliers (step S42). In the example shown in FIG. 11, since the same bid price, i.e., “37”, is for the radar signal processing application 43 of the node 2 and the radar signal processing application 53 of the node 3, the priority rank is designated in advance for these two applications, so that one of the two is selected. As an example, the radar signal processing application 43 is selected.

The successful bidder determination section 106 determines whether the bid price of the supplier is equal to or lower than a bid price presented by the consumer (step S43). In the example in FIG. 11, since the bid price provided by the radar information display application 45 is “1980”, the decision at step S43 is YES, and the successful bidder determination section 106 shifts the processing to step S44.

When the bid price of the supplier is higher than the bid price of the consumer, the decision at step S43 is NO, and the successful bidder determination section 106 terminates the processing.

At step S44, as a contract volume, the successful bidder determination section 106 determines, among the bids provided by the suppliers, a rate that does not exceed the remaining consumption volume. In the example in FIG. 11, since the supply volume 58 can be subtracted from the consumption volume 100 for the radar information display application 45, the supply volume 58, which does not exceed the consumption volume, is determined as a contract volume.

Sequentially, the successful bidder determination section 106 calculates the remaining consumption volume, i.e., subtracts the contract volume from the remaining consumption volume to obtain the resultant consumption volume (step S45). In the example in FIG. 11, the contract volume 58 is subtracted from the consumption volume 100, and the remaining consumption volume 42 is obtained.

Thereafter, the successful bidder determination section 106 determines whether the remaining consumption volume is equal to or smaller than 0 (step S46).

When the remaining consumption volume is greater than 0, the decision at step S46 is YES, and the processing is returned to step S42. When the remaining consumption volume is equal to or smaller than 0, the decision at step S46 is NO, and the processing is terminated.

At step S42, the processes at steps S41 to S46 are repeated forbids offered by suppliers other than the successful bidder.

The processes at steps S41 to S46 are repeated a predetermined number of times (three times in the embodiment). The processing at steps S41 to S46 corresponds to one round.

The number of repetitions is also determined in advance, and is three in this embodiment.

As described above, when a plurality of resource supply programs that supply a resource are included in a plurality of application programs, the bid management section 103 performs the resource allocation process in order to preferentially allocate a resource to a resource supply program that offers a lower bid price than the other programs.

(d) Round Repetition Control Section

The number of repetitions to perform the process explained while referring to FIG. 12 or 13 is counted by the round repetition control section 107. The round repetition control section 107 controls the successful bidder determination section 106 so that the process in FIG. 12 or 13 is not performed more than a predetermined number of times.

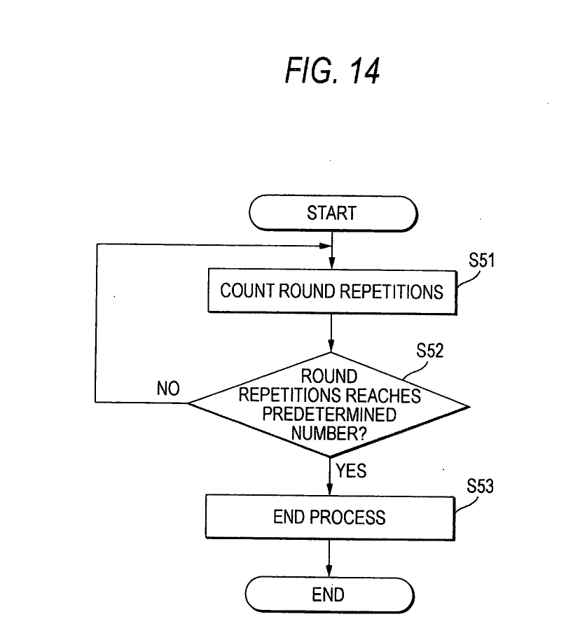

FIG. 14 is a flowchart showing example processing performed by the round repetition control section 107. The round repetition control section 107 counts the number of round repetitions (step S51). The round repetition control section 107 determines whether the number of round repetitions has reached a predetermined number, i.e., three in this embodiment (step S52). When the number of round repetitions has not reached the predetermined number, the decision at step S52 is NO, and the processing is returned to step S51). When the number of round repetitions has reached the predetermined number, the round repetition control section 107 performs the end process to terminate the process in FIG. 11 or 12 (step S53). During the end process, the above described end notification is output to the resource bidding section 102, with bidding results information, or separate from the bidding results information.

In this way, the round repetition control section 107 internally stores the number of rounds and increments the round count by one, and when the number of rounds has reached the upper limit, i.e., a predetermined number, ends the process, so that the performance of the process for anymore rounds is inhibited, i.e., the process is ended. An application creator may write the upper limit number to the source code of the application, or a user may designate the upper limit number directly or indirectly using a terminal.

By halting the process, it is ensured that bidding will be ended within a specific time period. A notification as to whether a round has been completed is transmitted as additional information when bidding results information is transmitted to a processing section that joined a bid.

### 5. Operation of the Entire Apparatus

Since appropriate parameters, such as predetermined variable values used for the bid price calculation section 104, are designated, as the final processing for the above described resource management apparatus, the radar information display application of node 2 receives radar information from the radar signal processing application of node 3, and starts the operation.

FIGS. 15 and 16 are tables showing the bidding state and the contract volume state of the resource management apparatus for the embodiment up to round “20”. In FIGS. 15 and 16, example data, such as a bid price, for the sequential twenty rounds are shown. Since the round repetition number in this embodiment is “3”, round 1 to round 3 indicate the passage and results of the first bidding processes, and round 4 to round 6 indicate the passage and results of the second bidding process. In the same manner, the bidding process for the process unit period is performed in three rounds.

As described above, according to the example shown in FIGS. 15 and 16, the processing is performed under a condition wherein, as a relation between the supply and consumption of a resource, the radar signal processing application requires a CPU usage rate of 135% for the generation of 100% of the radar information, the sonar signal processing application requires a CPU usage rate of 90% for the generation of 100% of the sonar information, the radar information display application requires a CPU usage rate of 90% for the generation of 100% of the radar information, and the sonar information display application requires a CPU usage rate of 35% for the generation of 100% of the sonar information. Further, in this case, a small variable value used for bid price calculation is “4” for a bid price and “3” for a bid volume. Furthermore, bid participants offer bids for four resources, i.e., the CPU usage rates, radar information and sonar information, which are to be allocated respectively to nodes 2 and 3, and the contract volumes and the contract prices of these resources are determined.

Resources are appropriately allocated in a round after the twentieth. According to the results in the twentieth round in FIGS. 15 and 16, the radar signal processing application of the node 2 generates 58% of radar information at a CPU usage rate of 78%, and the sonar signal processing application generates 37% of sonar information at the CPU usage rate of 42%. As for node 3, the radar signal processing application generates 42% of radar information at a CPU usage rate of 86%, and the sonar signal processing application generates 63% of sonar information at a the CPU usage rate of 56%.

These allocation results satisfy a condition in that the radar signal processing application requires a CPU usage rate of 135% for the generation of 100% of the radar information, and the sonar signal processing application requires a CPU usage rate of 90% for the generation of 100% of the sonar information. Further, the allocation results also satisfy a condition in that the radar information display application requires a CPU usage rate of 60% and the sonar information display application requires a CPU usage rate of 35%. Additionally, since the radar information display application has made a successful bid for 100% of the radar information and the sonar information display application has made a successful bid for 100% of the sonar information, these applications have also obtained all the data required for display. Although the operation is enabled in the round preceding the twentieth, a satisfactory CPU usage rate may not be allocated to the applications, and therefore, there is a possibility that the real time processing of the overall apparatus will not be satisfied. However, since this phenomenon occurs only at the initial bidding time, it does not become a serious problem for the overall operation.

In this embodiment, since radar information is more important than sonar information, the upper limit price is set so that signal processing and the preparation of information to be displayed for a radar signal should be performed prior to those for a sonar signal. In the above example, different upper limit prices for purchase prices are provided for the two sensor information display applications, and within a range extending up to their upper limit prices, the sensor information display applications purchase resources to consume, and perform the operations. When the upper limit prices are variable, in accordance with the situation, the importance levels of the applications can also be changed in accordance with the situation.

Further, the bid price of node 3 for the CPU usage rate is lower than bid price of node 2 because the radar information display application of node 2 made a successful bid for the CPU usage rate and the price thereof was raised. Accordingly, the bid price (purchase price), as a resource for radar information, is lower for the radar information processing application of node 3 than for the radar information processing application of node 2. Therefore, since the radar information display application 45 purchases radar information from the radar information processing application 53 of node 3, the radar information processing application 53 of node 3 performs the operation.

Additionally, since the final bid price storage section 105 is provided for the resource bidding section 102, the preceding bidding results are employed to calculate a bid price, until a bidding process in the next process unit period starts. Therefore, a phenomenon in that an extended time period is required to settle down to an appropriate state is avoided.

That is, since there is a possibility that the processing may be rendered inappropriate simply by halting the bidding process, as described above, a bidding process is performed during a plurality of rounds. This is because the resource allocation efficiency is improved, step by step. However, with a small number of rounds, the allocation efficiency may not be increased satisfactorily. In such a case, inefficient resource allocation may be performed through the bidding performed in each process unit period, i.e., correct resource allocation can not be performed while taking into account the importance level of a signal process for a specific aspect. When a final bid price storage section is not present, bid prices offered by a producer and a consumer begins at 0 in each process unit period, and it is necessary to repeat process by many rounds, twenty or more rounds in this embodiment, until an appropriate allocation state is reached. Therefore, as described above, in this embodiment, the preceding bid price is stored in the final bid price storage section, so that when the round repetition control section halts the process at a repetition, for example, of five rounds to ensure that bidding is ended within a predetermined time period, the appropriate allocation state is settled, for example, through the processing performed for four process unit periods.

The round halting condition for the embodiment is the number of repetitions. As a modification for the present invention, the round repetition control section may measure a round performance time period, and when a predetermined time period is reached, may halt the round.

An application creator may write the predetermined period to the source code of an application, or a user may designate this period directly or indirectly using a terminal. As a round halting method using time measurement, in the initial round, a timer may be set using a timer function provided by an OS, and when the period has elapsed, may transmit a notification to that effect to halt the round.

As another method, in the initial round, the real time clock of an OS may be read, time may be stored in the round repetition control section, and during each round, a difference between the current time and the time stored may be calculated to determine whether a specific period has been reached.

In the embodiment of the present invention, the sensor information system 1 includes two nodes 2 and 3 for simplification of the explanation. However, the system may include three or more nodes. Further, the radar 5 and the sonar 7 that output sensor signals are connected respectively to the nodes 2 and 3; however, a plurality of apparatuses that output sensor signals may be connected to a single node. That is, one node may not be connected to any apparatus that outputs a sensor signal, and the other node may be connected to a plurality of apparatuses that output a sensor signal.

Additionally, in the embodiment, two CPUs have been provided for each node. However, one CPU or three or more CPUs may be provided, and may be connected to other circuits by a bus internally provided for the individual nodes.

As described above, according to the embodiment of the invention, in the real time system that performs high-level bidding, such as supply chain bidding, rounds for bidding are halted in accordance with a condition, such as the number of repetitions or a time period, so that the real-time characteristic for bidding is ensured, and resource allocation can be performed. That is, in consonance with the importance of data, the resource management apparatus of this embodiment obtains a real-time characteristic and performs a corresponding application.

Further, since the final bid price in the preceding process unit period is stored and is used as the initial bid price for the next process unit period, a bid price becomes asymptotic, in the long run, relative to a bid price that is offered through a plurality of rounds that are not broken off.

The “section” in this specification are concepts corresponding to individual functions of the embodiment, and do not always correspond respectively to specific hardware or software routines. Therefore, in this specification, the embodiment has been explained by assuming the virtual circuit blocks (sections) having the functions of the embodiment. Further, the steps of the processing in this embodiment may be replaced, multiple steps may be performed at the same time, or at each performance of the processing, the steps may be performed in a different order.

A program that executes part or all of the above operations is stored on a portable storage medium, such as a floppy™ disk or a CD-ROM, or a storage device such as a hard disk. The program is read by a computer, and all or part of the operation is performed. Or, all or part of the program can be distributed via a communication network into a user. In order to obtain the resource management apparatus of the invention, users need only download the program via the network and install it in their computers, or need only read the programs from recording media and install them in their computers.

The present invention is not limited to this embodiment, and can be variously modified or altered without departing from the subject of the invention.

What is claimed is:

1. A resource management apparatus comprising:
a plurality of resource bidders that are respectively provided for a plurality of application programs, each of which consumes and/or supplies resources, each of the resource bidders calculating a current bid price for each of the resources to be supplied or consumed by the associated application program within a unit time to generate current bidding information about the current bid price;
a bid manager that performs an allocation process to allocate the resources to the application programs through a bidding process based on the current bidding information generated by each of the resource bidders; and
a repetition controller that controls the bid manager to repeat the allocation process until a bidding stop condition is satisfied within the unit time.

2. The apparatus according to claim 1, wherein each of the resource bidders calculates the current bid price each time when the bid manager performs the allocation process.

3. The apparatus according to claim 1,
wherein each of the resource bidders includes a storage that stores a final bid price at which the bidding is successful at last in a pervious unit time; and
wherein each of the resource bidder employs the final bid price stored in the storage as an initial price of the current bid price of the resource bidder in the unit time.

4. The apparatus according to claim 1, wherein the bidding stop condition is that the number of repetitions of the allocation process reaches a predetermined number.

5. The apparatus according to claim 1, wherein the bidding stop condition is that a time taken for the repetitions of the allocation process reaches a limit time within the unit time.

6. The apparatus according to claim 1, wherein the application programs include:
a first processing program that processes a radar signal obtained by a radar to generate radar information;
a first displaying program that controls a display to display the radar information;
a second processing program that processes a sonar signal obtained by the sonar to generate sonar information; and
a second displaying program that controls a display to display the sonar information.

7. A computer readable medium storing a program causing a computer to execute a process for managing resources to be consumed and/or supplied by each of a plurality of application programs, the process comprising:
calculating a current bid price for each of the resources to be supplied or consumed by the associated application program within a unit time to generate current bidding information about the current bid price;
performing an allocation process to allocate the resources to the application programs through a bidding process based on the current bidding information generated by the calculating step; and
repeating the allocation process until a bidding stop condition is satisfied within the unit time.

8. An information processing apparatus for managing resources to be consumed and/or supplied by each of a plurality of application programs, the apparatus comprising:
a memory;
a processor provided to be accessible to the memory, the processor being operable to perform a process comprising:
calculating a current bid price for each of the resources to be supplied or consumed by the associated application program within a unit time to generate current bidding information about the current bid price;
performing an allocation process to allocate the resources to the application programs through a bidding process based on the current bidding information generated by the calculating step; and
repeating the allocation process until a bidding stop condition is satisfied within the unit time.
